(19) United States
(12) Patent Application Publication
(10) Pub. No.: US 2025/0074026 A1
(43) Pub. Date: Mar. 6, 2025

(54) FORMING UNIT FOR A PACKAGING MACHINE AND METHOD THEREOF

(71) Applicant: P.F.M. S.p.A., TORREBELVICINO (VI) (IT)

(72) Inventors: Andrea FIORAVANTI, TORREBELVICINO (VI) (IT); Marco Giovanni PIERANTONI, TORREBELVICINO (VI) (IT)

(73) Assignee: P.F.M. S.p.A., TORREBELVICINO (VI) (IT)

(21) Appl. No.: 18/824,485

(22) Filed: Sep. 4, 2024

(30) Foreign Application Priority Data
Sep. 4, 2023 (IT) 102023000018147

(51) Int. Cl. B31B 70/00; B31B 70/10; B31B 155/00

(52) U.S. Cl. CPC B31B 70/001; B31B 70/10; B31B 2155/00

(57) ABSTRACT

A forming unit for a packaging machine comprises a conveyor for a flexible packaging material along a conveying direction; a forming assembly activatable on the flexible packaging material, and configured to shape it along a forming direction transverse to said conveying direction to form a package; an adjustment associated with the forming assembly and configured to move it nearer and/or farther away along the forming direction, so as to adjust a transversal dimension of the package.

### TECHNICAL FIELD

The present disclosure relates to a forming unit, in particular intended to be operatively associated with an automatic packaging machine.

In greater detail, the forming unit according to the present disclosure is intended to be used in the sector of the manufacture and sale of packaging machines or lines or systems, in particular of the horizontal type (HFFS), for the production of packages made of a flexible packaging material, for example a polymeric film, multilayer, paper or the like.

The forming unit according to the present disclosure has particular application in the sector of packages identified by the term “stand-up” or “doypack” in the technical jargon, and in particular made from a flexible packaging material that was previously formed, for example by calendaring, and preferably intended to contain fragile products, e.g. biscuits or the like.

### STATE OF THE ART

The use of assemblies or units for forming a flexible packaging material, suitable for being sealed around a predefined amount of product to produce a package, is well known in the technical sector of reference. In particular, for the packaging of fragile products (such as, for example, the abovementioned ones), the use of automatic horizontal packaging machines (HFFS) equipped with forming units capable of producing packages of the “stand-up pouch” or “doypack” type, i.e. packages made with a flexible packaging material capable of staying in an erect position (i.e. standing) when rested on a flat surface, such as for example a shelf or a shelving unit of a store or supermarket, is well known.

More specifically, such packages typically extend vertically and have a bottom portion, called “gusset” in the technical jargon, having a plurality of shapes, such as, in particular, square or rectangular.

A forming unit of the known type typically comprises a support structure, mounted on which there is a channel for conveying a flexible packaging material, such as, for example, a multilayer film, which extends along a processing direction.

The forming unit further comprises a plurality of diverter elements cooperating with the conveying channel in order to lend the flexible packaging material a desired conformation adapted to shape the flexible packaging material to produce a package of the abovementioned type. The forming unit of the known type briefly described thus far has revealed in practice not to be free of drawbacks.

In particular, the main drawback lies in the fact that the forming unit of the known type is operatively not very flexible. In fact, the forming unit of the known type is capable of producing packages having a format, i.e. a capacity to contain products, that is well defined and limited. For example, the unit of the known type is capable of producing packages in a format corresponding to a quantity of product substantially equal to 400 g or else substantially equal to 700 g.

It follows that automatic packaging machines equipped with a forming unit of the known type prove overall to be operatively not very flexible, since they are capable of producing packages having one of the formats mentioned above.

### SUMMARY

The present disclosure provides a forming unit for an automatic packaging machine that makes it possible to obviate and remedy, at least in part, the drawbacks of the abovementioned prior art.

A further object of the present disclosure is to provide a forming unit for a packaging machine that is operatively flexible, in particular which is capable of producing a wide range of package formats, and thus corresponding to multiple product containment capacities.

In other words, the object of the present disclosure is to provide a forming unit capable of performing an operation of forming (or shaping) a flexible packaging material in such a way as to lend the flexible material itself a desired format, i.e. corresponding to a desired containment capacity (i.e. weight).

In addition, a further object of the present disclosure is to provide a forming unit for a packaging machine that has an alternative and/or improved configuration, both in constructive terms and in functional terms, compared to the traditional known solutions, so as to produce a variety of package sizes in a simple, rapid manner and at low costs.

All the objects, both individually and in any combination thereof, and others that will emerge from the detailed description that follows, are achieved, according to the present disclosure, with a forming unit for a packaging machine having the features specified in the independent claim 1.

The dependent claims outline particularly advantageous embodiments of the packaging machine.

### BRIEF DESCRIPTION OF THE DRAWINGS

Additional features and advantages will emerge more clearly from the detailed illustrative and thus non-limiting description of a preferred but not exclusive embodiment of a forming unit for a packaging machine, as illustrated in the appended figures, in which:

FIG. 1 shows, according to a perspective view, a forming unit in use in a packaging machine, according to one embodiment;

FIG. 2 shows, according to a perspective view, the forming unit illustrated in FIG. 1;

FIG. 3 shows, according to a perspective view, the forming unit illustrated in FIG. 1 with some parts removed to better highlight others;

FIG. 4 shows, according to top plan view, the forming unit illustrated in FIG. 1;

FIG. 5 shows, according to a further perspective view, the forming unit illustrated in FIG. 1 with some parts removed to better highlight others;

FIG. 6 shows, according to a further perspective view, the forming unit illustrated in FIG. 1 with some parts removed to better highlight others.

With reference to the drawings, they serve solely to illustrate embodiments of the invention for the purpose of better clarifying, in combination with the description, the principles at the basis of the present disclosure.

### DETAILED DESCRIPTION OF THE INVENTION

With reference to the appended figures, the number 10 denotes in its entirety a forming unit, in particular intended to be operatively associated with a packaging machine.

For the purposes of the present description, the term “packaging machine” should thus be understood to mean an automatic machine, an apparatus, a line or any other automatic packaging system, preferably of the horizontal type (identified by the term “HFFS-Horizontal Form Fill and Seal”—in the technical jargon of the industry).

For the purposes of the present description, the term “format” should be understood to mean any configuration of a flexible packaging material intended to produce a package capable of containing a predefined amount of a product, for example 400 g.

In particular, the term “flexible packaging material” should be understood to mean any material, for example a polymeric, paper or multi-layer material, suitable for being wrapped and sealed around a product to be packaged, in particular fragile products such as, for example, biscuits or the like.

However, the forming unit according to the present disclosure can also be advantageously mounted on automatic packaging machines adapted to produce packages of products of another nature, for example sweets, chocolates and still others.

In addition, in the description below particular reference will be made to a package of the abovementioned type (i.e. stand-up pouch). Such packages have a substantially square or rectangular shape in a bottom portion thereof.

However, the unit according to an embodiment can also be advantageously used to form other types of pouches, for example provided with zip closures or the like.

In accordance with an embodiment as illustrated in the appended figures, the forming unit 10 for a packaging machine 100 comprises a support structure 11 extending mainly along a direction of movement Y of a flexible packaging material, between a first end 11a and a second end 11b.

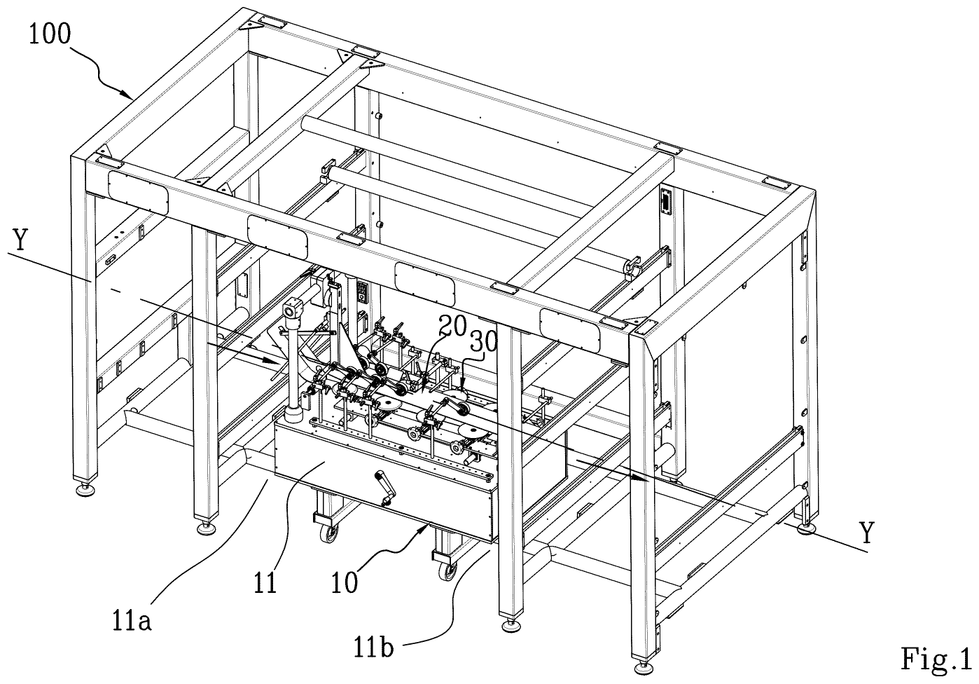

In greater detail, the flexible packaging material enters the forming unit 10 at the first end 11a and exits from the unit 10 itself at the second end 11b. As illustrated in FIG. 1, the direction of movement Y is preferably substantially horizontal, i.e. substantially parallel to the ground.

The support structure 11 is preferably made of a metal material, in particular steel, and comprises movement means 12, such as, for example, wheels or castors, rotatably connected to the support structure 11 and intended to rest on the ground to allow a movement of the forming unit 10, for example relative to a packaging machine 100 (see FIG. 1).

According to one aspect, the forming unit 10 comprises conveying means 20 configured to convey the flexible packaging material along the conveying direction Y.

In greater detail, the conveying means 20 comprises a first longitudinal element 21 extending parallel to the conveying direction Y, between the first end 11a and the second end 11b. In particular, the first longitudinal element 21 has a curved portion 21″ disposed at the first end 11a to facilitate the entry of the flexible packaging material into the forming unit 10.

The conveying means 20 further comprises a second longitudinal element 22 disposed facing the first longitudinal element 21, and mechanically connected to the first longitudinal element 21.

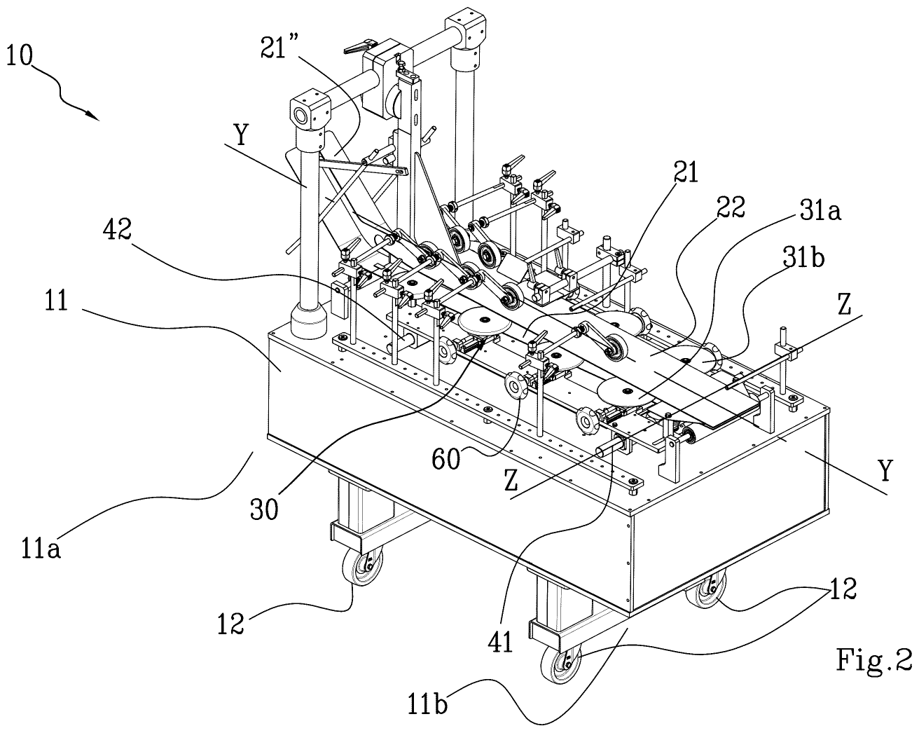

According to one aspect, the first longitudinal element 21 has a substantially planar shape, and the second longitudinal element 22 is shaped substantially analogously to the first longitudinal element 21. In particular, as illustrated in FIGS. 2-4, the first longitudinal element 21 and the second longitudinal element 22 have a main surface thereof disposed substantially parallel to the ground.

The mechanical connection between the two aforesaid longitudinal elements 21, 22 takes place in a respective middle portion, in particular through the interposition of a plate-like metal element disposed substantially orthogonally to the planar surface of the first and second longitudinal elements 21, 22.

In other words, the conveying means 20 has the shape a substantially H-shaped longitudinal cross section inclined by 90°.

In this manner, a forming means 30 (introduced and described in greater detail below) can be inserted, at least partially, between the first and second longitudinal elements 21, 22 and shape the flexible packaging material.

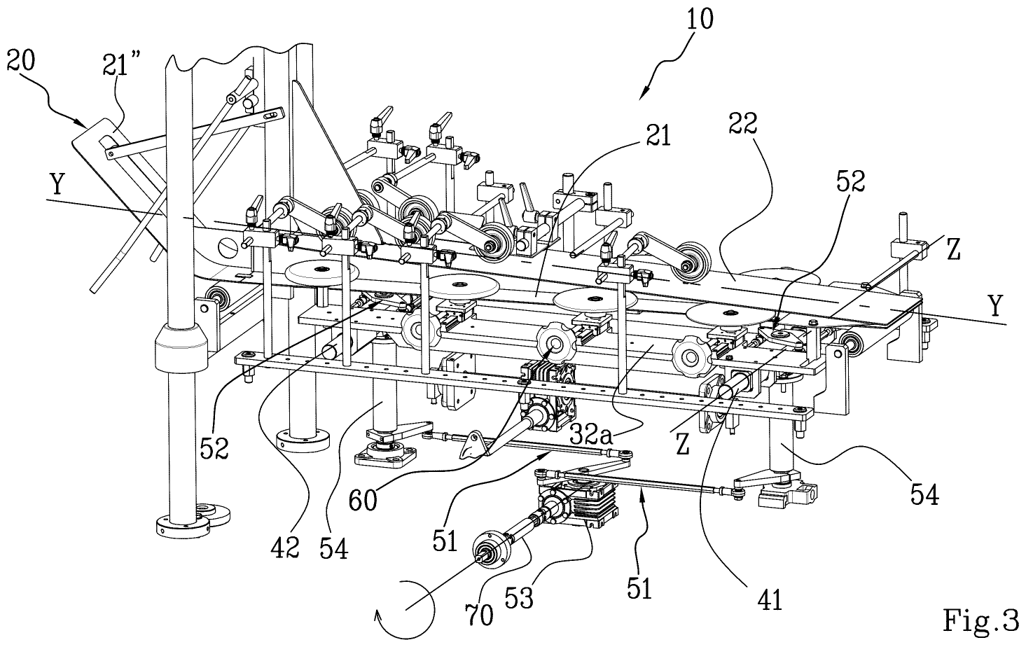

As illustrated in FIGS. 2 and 3, the first longitudinal element 21 and the second longitudinal element 22 are arranged in such a way as to define a channel for conveying the flexible packaging material. In particular, the conveying channel has a preferably substantially tapered shape, in particular tapered from the first end 11a towards the second end 11b.

The first and second longitudinal elements 21, 22, and the plate-like element interposed between the aforesaid elements are preferably made of metal material, in particular steel, and connected to each other, for example by means of a welding process.

In accordance with an embodiment, the forming unit 10 comprises forming means 30 activatable on the flexible packaging material and configured to shape the material itself along a forming direction Z transverse to the conveying direction Y to form a package.

In particular, the forming direction Z is preferably substantially orthogonal to the conveying direction Y.

According to one aspect illustrated in FIG. 3, and as mentioned above, the forming means 30 is configured to be inserted, at least partially, into the conveying channel, in particular between the first longitudinal element 21 and the second longitudinal element 22, so as to shape the flexible packaging material while it is sliding along the conveying direction Y.

Advantageously, the forming means 30 allows a desired shape to be lent to the flexible packaging material, according to the geometry assumed by the forming means 30. It follows that, in order to lend a desired shape to the flexible packaging material, it will be necessary to modify the shape of the aforesaid forming means 30.

According to one aspect of the invention, the forming means 30 comprises a first discoidal element 31a and a second discoidal element 31b, activatable on a respective portion of the flexible packaging material to shape it so as to form a package.

In particular, according to a non-illustrated embodiment, at least one of the at least a first discoidal element 31a and/or the at least a second discoidal element 31b is reversibly movable between a plurality of different operating positions.

According to the preferred embodiment illustrated in the appended figures, the first discoidal element 31a and the second discoidal element 31b are substantially equal to each other and are preferably organized as a pair.

More specifically, the first discoidal element 31a is disposed in a lateral portion of the conveying means 20, preferably at least partially inserted into the conveying channel, and the second discoidal element 31b is preferably disposed facing the first discoidal element 31a, in a lateral portion opposite the lateral portion of the first discoidal element 31a.

In other words, the first discoidal element 31a and the second discoidal element 31b cooperate with each other in a pair, in particular each in corresponding lateral portions of the conveying channel and thus of the flexible packaging material.

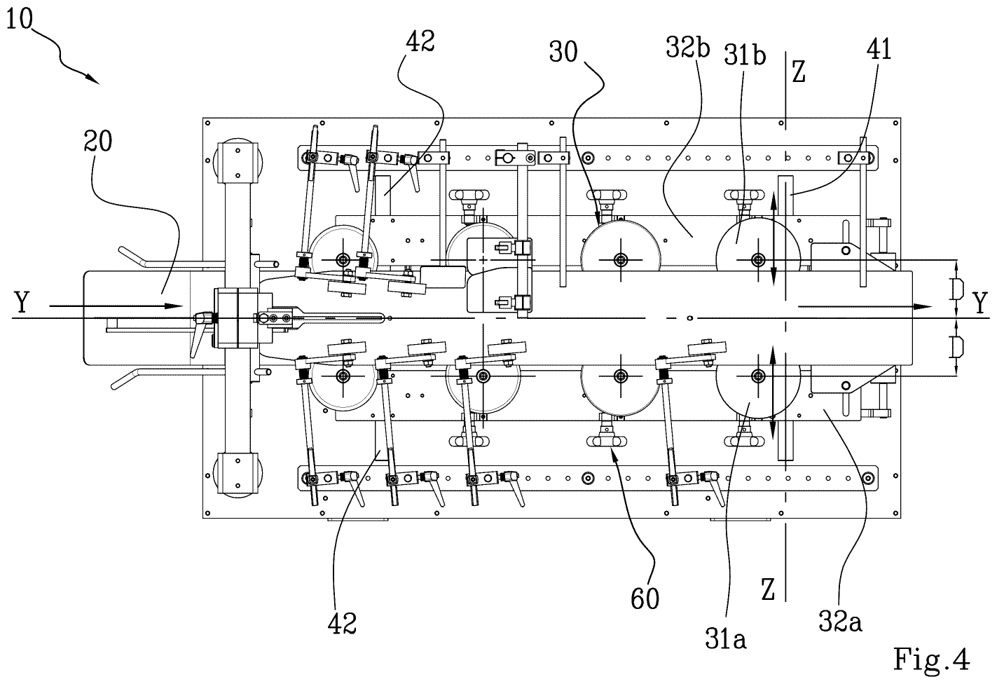

As illustrated in detail in FIGS. 4-6, the forming means 30 preferably comprises a plurality of discoidal elements 31a, 31b, preferably organized in pairs.

In particular, a first part of the plurality of discoidal elements 31a, preferably four discoidal elements, is arranged substantially parallel to a lateral edge portion of the conveying channel. A second part of the aforesaid plurality of discoidal elements 31b, preferably four discoidal elements, is arranged substantially parallel to the first part of discoidal elements and facing the latter, so as to form pairs of discoidal elements 31a, 31b.

The number of discoidal elements 31a, 31b depends on the extent of the channel for conveying the flexible packaging material.

Furthermore, each discoidal element 31a, 31b has its own rotation axis, preferably oriented substantially vertically.

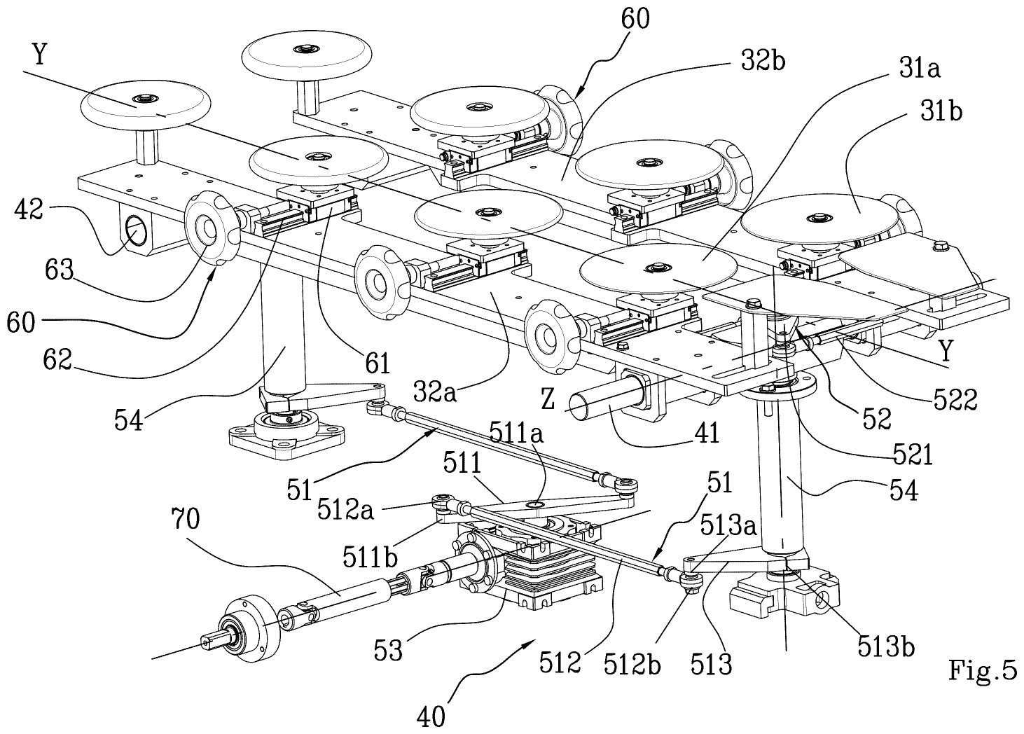

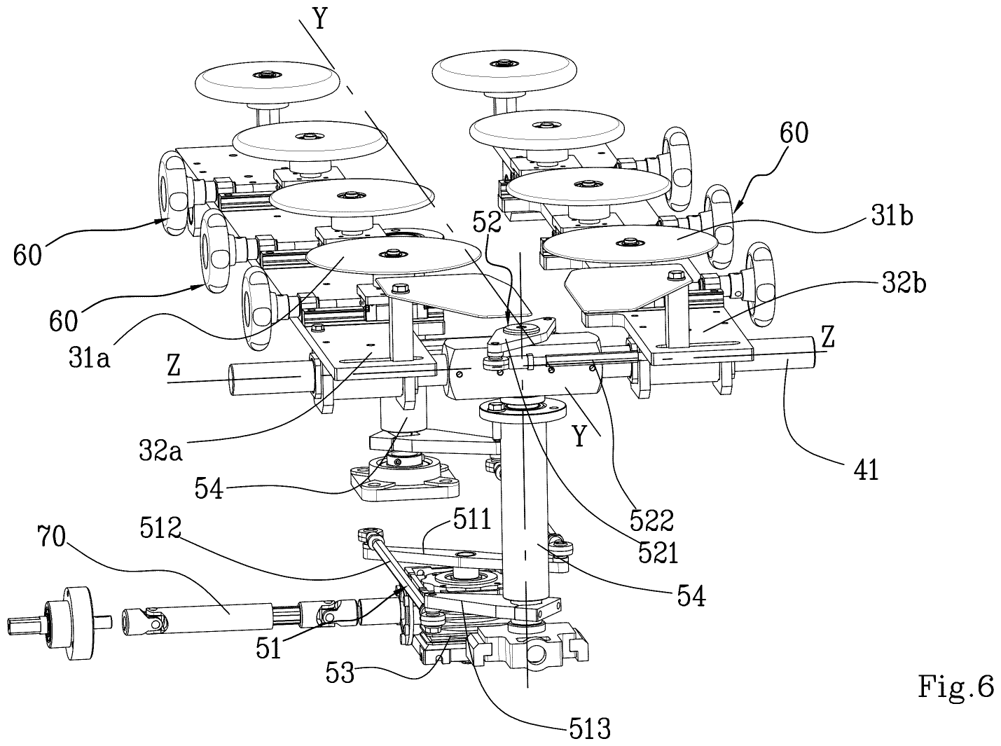

According to one aspect illustrated in detail in FIGS. 5-6, each of the discoidal elements 31a, 31b is mounted on an adjustment device 60, which can preferably be manually driven. In greater detail, the adjustment device 60 comprises a sliding block 61 on which a first or a second discoidal element 31a, 31b and a rail 62 are rotatably mounted. Each rail 62 is disposed oriented parallel to the forming direction Z, and mechanically and integrally mounted on the first bar 32a and on the second bar 32b. The sliding block 61 is coupled to the rail 62 by means of a prismatic coupling.

In particular, the movement of the sliding block 61 along the rail 62 is preferably achieved by means of a threaded bar, preferably manually driven, for example by means of a handwheel 63.

Advantageously, each discoidal element 31a, 31b can be manually moved along the forming direction Z, in particular each independently of the others. In this manner, one introduces into the forming unit 10 a degree of freedom of adjustment of the forming means in addition to the degree of freedom associated with the simultaneous movement of the forming means itself, as described in greater detail below.

According to one aspect, the forming means 30 comprises a first bar 32a and a second bar 32b extending substantially parallel to the conveying direction Y, and wherein the first and second discoidal elements 31a, 31b are respectively mounted rotatably on the aforesaid first and second bars 32a, 32b.

In particular, the first bar 32a has a substantially plate-like, elongate shape. The second bar 32b has a shape that is substantially equal to the shape of the first bar 32a.

According to one aspect, the first and second bars 32a, 32b are reversibly movable in such a way as to move the first and the second discoidal element 31a, 31b reciprocally nearer and/or farther apart.

In particular, in order to achieve this movement, the first bar 32a and the second bar 32b are slidably mounted on a first sliding guide 41 (introduced and described in greater detail below).

According to one aspect which is not illustrated in the appended figures, the aforesaid first and second discoidal elements can have a shape differing from the one illustrated in the appended figures, for example substantially oval, oblong or the like.

According to the embodiment illustrated in the appended figures, the forming unit 10 comprises an adjustment means 40 associated with the forming means 30 and configured to move it closer and/or farther away along the forming direction Z, so as to adjust a transversal dimension D of the package being formed.

In greater detail, the adjustment means 40 comprises at least one sliding guide 41, and in particular the forming means 30 is slidably mounted on the at least one sliding guide 41.

In accordance with the embodiment illustrated in the appended figures, the adjustment means 40 preferably comprises two sliding guides, in particular a first sliding guide 41 and a second sliding guide 42, arranged substantially parallel and preferably facing each other, and extending substantially parallel to the forming direction Z, i.e. orthogonally to the conveying direction Y.

According to one aspect, the first bar 31a and the second bar 31b are slidably mounted on the first sliding guide 41 and on the second sliding guide 42.

In particular, the forming means 30 is slidably mounted on the first sliding guide 41 and on the second sliding guide 42, in particular by means of a cylindrical sliding coupling, for example by means of slide bushings or the like.

According to one aspect, the slide bushings are integrally mounted on the first bar 32a and on the second bar 32b, in particular at the first end 11a and at the second end 11b, i.e. in end portions of the aforesaid bars.

Advantageously, the forming means 30 is capable of sliding, in particular by means of an alternating linear motion, along the first sliding guide 41 and the second sliding guide 42, so as to vary the distance thereof along the forming direction Z relative to the direction of movement Y.

According to one aspect illustrated in detail in FIGS. 4-6, the adjustment means 40 comprises an articulated mechanism active on the first bar 32a and the second bar 32b in such a way as to allow a substantially synchronous movement thereof along the forming direction Z.

Preferably, the articulated mechanism is activatable between a working configuration, in which the forming means 30 moves nearer to the flexible packaging film and cooperates with the latter; and a rest configuration, in which the forming means 30 is distal relative to the flexible packaging film.

In other words, the articulated mechanism moves the aforesaid forming means 30 along the forming direction Z so as to activate and/or deactivate it with respect to the flexible packaging film.

The active and/or rest configurations correspond respectively to a proximal and distal position of the forming means 30 relative to the flexible packaging film.

Preferably, the articulated mechanism allows the forming means 30 to take on a plurality of intermediate positions between the aforesaid active and rest configurations.

According to one aspect, the first articulated mechanism is preferably of the flat type, i.e. all the positions and speeds of the members making it up lie in a plane that is substantially parallel to the ground.

In greater detail, the articulated mechanism moves the first bar 32a and the second bar 32b by a same distance, nearer and/or farther away, and, consequently, this determines the movement of the first and second discoidal elements 31a, 31b.

The articulated mechanism is rigidly connected to the first and second bars 32a, 32b so as to define a unique movement. In other words, corresponding to a movement of the articulated mechanism there is a proportional movement of the first and second bars 32a, 32b and thus of the discoidal elements integral with the bars.

As illustrated in FIGS. 4-6, the articulated mechanism comprises a four-bar linkage 51 and a slider-crank mechanism 52 kinematically associated with the four-bar linkage 51 and configured to drive the movement of the first bar 32a and the second bar 32b along respectively the first sliding guide 41 and the second sliding guide 42.

More specifically, the four-bar linkage 51 and the slider-crank mechanism 52 are mechanically connected to each other, in particular in succession (i.e. in series) and cooperate so as to reciprocally and simultaneously move the forming means 30, in particular the first bar 32a and the second bar 32b carrying the discoidal elements 31a, 31b.

In accordance with a preferred embodiment illustrated in detail in FIGS. 5 and 6, the adjustment means 40 comprises two articulated mechanisms, in particular a first and a second articulated mechanism, substantially equal to each other.

The first articulated mechanism will be described below; that description is also deemed valid for the second articulated mechanism, as it is wholly analogous to the first articulated mechanism.

In particular, the first articulated mechanism comprises a four-bar linkage 51 and a slider-crank mechanism 52 rigidly connected to each other so that the movement of the four-bar linkage 51 corresponds to a proportional movement of the slider-crank mechanism 52.

More specifically, the first four-bar linkage 51 comprises:
a first member 511 having an elongate shape, extending between a first end 511a and a second end 511b, and configured to rotate about an axis that is substantially orthogonal to the conveying direction Y, i.e. substantially vertical, at the first end 511a. In other words, the first member 511 is the driving member of the first four-bar linkage 51, and is adapted to receive motion from an actuation means (introduced and described in greater detail below);
a second member 512 having an elongate shape, extending between a third end 512a and a fourth end 512b, and connected to the second end 511b of the first member 511 at the third end 512b thereof. The second member 512 is a connecting rod, and is configured to transmit motion between the first member 511 and,
a third member 513 having an elongate shape, extending between a fifth end 513a and a sixth end 513b, and connected to the fourth end 512b of the second member 512 at the fifth end 513a.

According to one aspect, the third member 513 of the first four-bar linkage 51 is rigidly connected to the slider-crank mechanism 52 by means of a sleeve 54, in particular at the sixth end 513b. More specifically, the sleeve 54 extends along an axis that is substantially orthogonal to the ground (i.e. substantially vertically) and is adapted to transmit motion, in particular rotational oscillatory motion, received from the third member 513 of the first four-bar linkage 51 to the slider-crank mechanism 52.

In other words, the sleeve 54 rigidly connects the first four-bar linkage 51 to the slider-crank mechanism 52 and is preferably made from a portion of hollow tubing.

As illustrated in detail in FIGS. 5-6, the first articulated mechanism comprises two slider-crank mechanisms 52, rigidly connected and substantially equal to each other. In particular, the first slider-crank mechanism 52 is connected to the first bar 32a in order to move it, whilst the second slider-crank mechanism 52 is connected to the second bar 32b in order to move it.

For the sake of simplicity of illustration, only the first slider-crank mechanism 52 will be described below, since the second slider-crank mechanism is substantially wholly analogous to the first.

According to one aspect, as previously mentioned for the first four-bar linkage 51, the first slider-crank mechanism 52 is preferably of the flat type, in particular the speeds and positions of each member of the slider-crank mechanism 52 lie in one plane. This plane is substantially parallel to the plane in which the first four-bar linkage 51 lies, i.e. substantially parallel to the ground, and situated in a higher position than the plane in which the first four-bar linkage 51 lies.

In greater detail, the first slider-crank mechanism 52 comprises a crank 521 having an elongate shape and mechanically connected at one end thereof to the sleeve 54, so as to rotate about a geometric axis of the sleeve 54 itself. In other words, the crank 521 is integrally connected to the sleeve 54 at one end thereof.

At the end opposite the one just described, the crank is connected to a connecting rod 522. More specifically, the connecting rod 522 has an elongate shape and is mechanically connected to the first bar 31a to move it along the forming direction Z.

The connecting rod 522 is adapted to transform the rotational motion of the crank 521 into an alternating linear translational motion (to move nearer and/or farther away) of the first bar 31a to which it is connected. The alternating linear translational motion is allowed by the fact that the first bar 31a is slidably mounted on the first sliding guide 41 (as mentioned above).

According to one aspect which is not illustrated in the appended figures, the articulated mechanism can comprise, as an alternative to the aforesaid slider-crank mechanism, a screw mechanism, such as, in particular, a trapezoidal screw or ball screw mechanism, or in general an articulated mechanism capable of transforming a rotational motion into an alternating linear movement.

The forming unit 10 further comprises an actuation means activatable on the adjustment means 40 and configured to drive the movement of the forming means 30. In particular, the actuation means comprises an electric drive and/or a manual drive.

According to one aspect, the electric drive comprises a motor (not illustrated in the appended figures), in particular of the electric type, for example a brushless or asynchronous motor.

As illustrated in FIGS. 5-6, the motor is preferably intended to be mechanically connected to the first and second articulated mechanisms, in particular to the first and second four-bar linkages 51, and configured to supply a power adapted to drive a rotation of the first and second four-bar linkages 51, in particular to the first member 511.

According to one aspect, the forming unit 10 comprises a reduction gearbox 53, interposed between the actuation means and the first and second articulated mechanisms.

The reduction gearbox 53 is preferably of the right-angle type, preferably of the worm type.

Advantageously, the rotation axis of the first member 511, and thus the direction along which the movement of the first and second articulated mechanisms takes place, can be diverted by an angle substantially equal to 90°. Therefore, as illustrated in FIGS. 5 and 6, the power supplied by the actuation means enters the reduction gearbox 53 along an axis substantially parallel to the forming direction Z, i.e. substantially parallel to the ground.

In other words, the use of the reduction gearbox 53 allows the movement of the first and second articulated mechanisms to be driven in a lateral position of the support structure 11 of the forming unit 10, rather than in a position interposed between the support structure 11 and the ground.

In addition, the reduction gearbox 53 advantageously makes it possible to reduce the speed between the actuation means and the speed of movement of the first and second four-bar linkages 51, and thus of the first and second slider-crank mechanisms 52 and, finally, of the discoidal elements connected to the crank mechanisms.

According to one aspect, the actuation means, in particular the electric motor, is mechanically connected to the reduction gearbox 53 by means of a drive shaft 70.

According to one aspect of the invention, as mentioned above, the reduction gearbox and thus of the four-bar linkage 51 and the slider-crank mechanism 52 can be manually driven. In greater detail, the manual drive can be achieved by means of a crank mechanically rotatably mounted at one end of the drive shaft 70 in order to bring the shaft itself into rotation about the geometric axis thereof.

The opposite end of the drive shaft 70 is mechanically connected to the reduction gearbox 53.

The present disclosure also provides method for adjusting a forming unit 10, preferably implementable with a packaging machine 100 of the above-described type and for which the same numerical references will be maintained for the sake of simplicity of illustration.

The method comprises the following steps:
providing a forming unit 10 according to one or more of the appended claims;
adjusting the positioning of the forming means 30.

1. A forming unit for a packaging machine, comprising:
a conveyor configured to convey a flexible packaging material along a conveying direction;
a forming assembly activatable on the flexible packaging material, and configured to shape the flexible packaging material along a forming direction transverse to the conveying direction to form a package;
the forming assembly comprising:
a first discoidal element and a second discoidal element activatable on a respective portion of the flexible packaging material to shape it so as to form a package; and
a first bar and a second bar extending substantially parallel to said conveying direction, wherein the first discoidal element and the second discoidal element are respectively mounted rotatably on both the first and the second bar and wherein the first and second bars are reversibly movable in such a way as to move the first discoidal element and the second discoidal element reciprocally nearer and/or farther apart;
an adjustment element associated with the forming assembly and configured to move it nearer and/or farther away along the forming direction, so as to adjust a transversal dimension of the package, wherein the adjustment element comprises an articulated mechanism activatable on the said first bar and the second bar in such a way as to allow a substantially synchronous movement thereof along the forming direction.

2. The forming unit of claim 1, wherein the adjustment element comprises at least one sliding guide; and
wherein the forming assembly is slidably mounted on the at least one sliding guide.

3. The forming unit of claim 1, wherein the adjustment assembly comprises a first sliding guide and a second sliding guide arranged substantially parallel to each other and extending substantially parallel to the forming direction; and
wherein the forming assembly is slidably mounted on the first sliding guide and the second sliding guide.

4. (canceled)

5. The forming unit of claim 1, wherein at least one of the at least one first discoidal element and/or at least one of the at least one second discoidal element is reversibly movable between a plurality of different operating positions.

6. The forming unit of claim 1, wherein the first bar and the second bar are slidably mounted on said first sliding guide.

7. (canceled)

8. The forming unit of claim 1, wherein the articulated mechanism comprises:
a four-bar linkage, and
a slider-crank mechanism kinematically associated with the four-bar linkage and configured to drive the movement of the first bar and the second bar along respectively the first sliding guide and the second sliding guide.

9. The forming unit of claim 1, comprising an actuation element activatable on the adjustment element and configured to drive the movement of the forming assembly, wherein the actuation element comprises an electric drive and/or a manual drive.

10. (canceled)
